(19) United States
(12) Patent Application Publication
(10) Pub. No.: US 2003/0175583 A1
(43) Pub. Date: Sep. 18, 2003

(54) Nonaqueous electrolyte cell and its manufacturing method

(76) Inventor: Isao Suzuki, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/362,162

(22) PCT Filed: May 2, 2002
(86) PCT No.: PCT/JP02/04380

(30) Foreign Application Priority Data
May 9, 2001 (JP) 2001138508
Jul. 19, 2001 (JP) 2001219078

(51) Int. Cl. H01M 10/52; H01M 10/34; H01M 10/40

(52) U.S. Cl. 429/57; 429/306; 29/623.2

(57) ABSTRACT

A non-aqueous cell according to the present invention has an assembly element comprising a positive electrode, a negative electrode, and a separator in a sealed case with the features: an amount of electrolyte is greater than or equal to 30% and less than or equal to 100% of the total pore volume of said assembly element; and a carbon dioxide content is greater than or equal to 1 volume % of the total gas contained in said sealed case.

### FIELD OF THE INVENTION

The present invention relates to a non-aqueous lithium battery and its manufacture process.

### DESCRIPTION OF THE RELATED ART

There needs the urgent demand for higher performance of battery to meet the rapid development of portable electric equipments. The one of candidates is secondary battery with metallic lithium. The battery has the merit of high energy density because the used metallic lithium shows the least noble potential and the lowest density among existing metals. Furthermore, lithium ion cells were invented using lithium cobaltate as positive active material and graphite or carbon as negative active material. This type cells have been used as the high energy density for the power sources of portable electric equipments.

However these types of non-aqueous battery need a large amount of liquid electrolyte and a polyolefin insulator separator with flammable properties resulting in the poor safety as a technical problem. There has been the attempt to reduce a amount of electrolyte as thoroughly as possible. These efforts resulted in new technical problem of drastic decrease in discharge performance. As the present status of these efforts, the limit of reduced level was an amount of electrolyte of 130% of the total pore volume of an assembly of a positive electrode, a negative electrode, and a separator without liquid electrolyte. The existence of its limitation has been considered to be the enlargement in internal resistance caused by the insufficient spread of electrolyte into the space between the separators and both positive and negative electrodes below the value of around 130%.

On the contrary, the tremendous experiments on the detailed mechanism by applicant revealed that the real cause of the existence o electrolyte limit was the immature formation of protection film on the surface of positive and negative active materials. Namely, the uncovered surface without the protection film on active materials at the site of no contact of electrolyte remains under the condition of below or equal to the value of 100% of the total pore volume of an assembly of a positive electrode, a negative electrode, and a separator at the first charge process. The part of uncovered surface of active materials contact the electrolyte redistributed by the expansion and contraction in volume change of active materials caused by the following charge-discharge reaction process. At the site of re-contact of electrolyte with active materials, the gas evolution starts by the reduction reaction of electrolyte with the formation of protection film resulting in the bulge of cell case by the pressure increase by its gas evolution. This expansion of cell volume increases the pore volume in cells resulting in the further shortage of electrolyte needed for filling the space. In that case, the uneven contact of electrolyte with the surface of active materials will cause the uneven current distribution of electrode resulting in the large polarization in discharge process. The performance of the cell therefore decreases with charge-discharge cycles. As a well-known phenomenon, the formation of protection film occurs with the gas evolution caused by the electrolyte decomposition reaction on the negative electrode at the first charging process. The film suppresses the electrolyte decomposition reaction after the subsequent charge processes. The (CH₂OCO₂Li)₂ and Li₂CO₃ as a composition of this film are only reported for example in Journal of Power Sources 81-82, 212-216(1999). The new failure mechanism mentioned above has not been found so far.

The present invention provides a non-aqueous cell with longer cycle life and high safety performances by the existence of carbon dioxide in the cell to form the protection film under the reduced amount of electrolyte, wherein the film suppresses the gas evolution caused by the contact of electrolyte and active materials.

### DISCLOSURE OF THE INVENTION

A non-aqueous cell according to the invention has the features; a carbon dioxide content is greater than or equal to 1 volume % of the total gas contained in a cell case; an amount of electrolyte is greater than or equal to 30% and less than or equal to 100% of the total pore volume of an assembly element composed of a positive electrode, a negative electrode, and a separator before filling the electrolyte; and the assembly element with the electrolyte is held in the cell case.

The effect of reduction of electrolyte of greater than or equal to 30% and less than or equal to 100% of the total pore volume of the assembly element remarkably is to improve the safety performance. The case of simple application of reduction of electrolyte leads to the remained part of no formation of the protection film on active materials by the no contact of electrolyte at the first charging process followed by the gas evolution at the subsequent charge-discharge cycles. The invention takes the additional technology of the existence of carbon dioxide content of greater than or equal to 1 volume % of the total gas contained in a cell case under the limited amount of electrolyte. The effect of injection of carbon dioxide according the present invention is to suppress the progress of the film formation accompanied with the gas evolution during the charge-discharge cycles even in the new contact of electrolyte on the part of active materials with no contact of electrolyte in the first charging process by the pre-formation of lithium carbonate like film on the active materials with no contact of electrolyte caused by the reduction reaction of carbon dioxide injected in the cell at least before the end of first charge. The injected carbon dioxide is the same composition of gas produced by the decomposition of electrolyte at the positive electrode resulting in the suppression of progress of the decomposition reaction accompanied with gas evolution at the positive electrodes. In the case of small amount of electrolyte, especially less than or equal to 100% of the total pore volume of the assembly elements wherein both liquid electrolyte and gas phases are existed in the pores of assembly element, the injected carbon dioxide gas is easily transferred to the surface and its micro-pore of the active materials directly through gas phase resulting in the evenness of the film formation on the surface of active materials. In the case of large amount of electrolyte, especially greater than 100% of the total pore volume of the assembly elements wherein the liquid electrolyte occupied the almost of pores in the assembly element, the injected carbon dioxide gas has to be transferred to the surface and its micro-pore of the active materials through liquid phase resulting in the difficulty of the film formation on the surface of active materials by its carbon dioxide.

The manufacture of the present invention is comprising the following processes for example: the assembly process of a positive electrode, a negative electrode, and a separator; the housing process of an assembly element into a cell case; and the pouring process of electrolyte of greater than or equal to 30% and less than or equal to 100% of the total pore volume of the assembly element followed by the injection process of the carbon dioxide content greater than or equal to 1 volume % of the total gas contained in the cell case. As an embodiment by the present invention, it is preferable that the porous polymer electrolyte exists at least in the part of either pores of element of a positive electrode, a negative electrode and a separator, on the surface of these elements, or on the positive and negative active materials. More preferably, the separator is replaced by the porous polymer electrolyte. Furthermore, the porous polymer electrolyte formed on the surface of positive and negative electrodes has the function of existing separators. The positive and negative electrodes with separators are to be integrated as one body.

In the case of no formation of porous polymer electrolyte on the surface of active materials, the reduction reaction of carbon dioxide occurs in almost all the part of their surfaces resulting in the almost full coverage of lithium carbonate produced by its reaction. The lithium ion is then difficult to transfer through its solid film of lithium carbonate.

In the case of the formation of porous polymer electrolyte on the surface of positive active materials and/or negative active materials, the cycle performance of cells is further improved by the smooth transference of lithium ion through the polymer electrolyte formed on the surface of active materials whereas the film formation is easily occurred in the pore part of polymer electrolyte on the surface of active materials by the smooth reduction reaction of carbon dioxide to suppress the gas evolution. Namely, there are two parts of surface; the one part is covered by the polymer electrolyte contributing the smooth transference of lithium ion and the other is uncovered parts contributing the film formation for suppression of gas evolution during cycling resulting in a longer cycle performance mainly by the further even current distribution. The manufacture of this type cells according to the present invention is comprising the following processes for example: the coating process of polymer solution on the surface of positive active materials and/or negative active materials; the formation process of porous polymer on their surface by excluding the solvent used for the former polymer solution; the manufacture process of the positive electrode with said positive active materials and the negative electrode with said negative active materials; the assembling process of the positive electrodes, negative electrodes and separators; the housing process of the said assembly elements into the cell case; and the pouring process of electrolyte of greater than or equal to 30% and less than or equal to 100% of the total pore volume of the assembly elements followed by the injection process of the carbon dioxide content greater than or equal to 1 volume % of the total gas contained in the cell case.

In the case of the formation of porous polymer electrolyte on the surface and the pores of positive electrode and/or negative electrode, the cycle performance of cells is also further improved by eliminating the most of all space between separators and both electrodes with the expansion of polymer electrolyte on the surface by swollen property with liquid electrolyte, wherein the space with the shortage of the amount of electrolyte is not observed result in the suppression of soft short caused by the dendritic growth of metallic lithium according to the increase in the polarization. Furthermore, in the case of the formation of polymer electrolyte both in the pore and the surface of the positive electrodes/or negative electrodes, the gas of carbon dioxide easily moves into their pores of its polymer electrolyte resulting in the even distribution of carbon dioxide within the cells. Therefore, the formation of the coated film of lithium carbonate evenly forms on the surface of their active materials wherein the part of its formation is on the site of the pore of the polymer electrolyte. The lithium ion is more easily transferred in the part of the site of the polymer electrolyte materials not covered by lithium carbonate film result in the even current-distribution and a longer life cycle performance.

The manufacture of one type cells according to the present invention is comprising the processes for example: the coating process of polymer solution on the surface of positive electrodes and/or negative electrodes; the formation process of porous polymer on their surface by excluding the solvent used for the former polymer solution; the assembling process of the positive electrodes, negative electrodes and separators; the housing process of the said assembly elements into the cell case; and the pouring process of electrolyte of greater than or equal to 30% and less than or equal to 100% of the total pore volume of the assembly elements followed by the injection process of the carbon dioxide content greater than or equal to 1 volume % of the total gas contained in the cell case. The manufacture of another type cells according to the present invention is comprising the following processes for example: the holding process of polymer solution into the pores of positive electrodes and/or negative electrodes; the formation process of porous polymer in the pores by excluding the solvent used for the former polymer solution; the assembling process of the positive electrodes, negative electrodes and separators; the housing process of the said assembly elements into the cell case; and the pouring process of electrolyte of greater than or equal to 30% and less than or equal to 100% of the total pore volume of the assembly elements followed by the injection process of the carbon dioxide content greater than or equal to 1 volume % of the total gas contained in the cell case.

In addition, the formation of porous polymer electrolyte on the separator also has the effect of reducing the almost part of gap between the separator and the both electrodes by the above-mentioned swollen property resulting in the improvement of the cycle performance. The manufacture of this type cells according to the present invention is comprising the processes for example: the coating process of polymer solution on the separator; the formation process of porous polymer on the separator by excluding the solvent used for the former polymer solution; the assembling process of the positive electrodes, negative electrodes and said separators; the housing process of the said assembly elements into the cell case; and the pouring process of electrolyte of greater than or equal to 30% and less than or equal to 100% of the total pore volume of the assembly elements followed by the injection process of the carbon dioxide content greater than or equal to 1 volume % of the total gas contained in the cell case. In that case, the separator integrated with at least either the positive electrode or negative electrode using the porous polymer electrolyte enables to be no slight gap between the separator and both electrodes resulting in the drastic improvement of cycle performance.

### BRIEF DESCRIPTION OF THE DRAWINGS

FIG. 1 shows the cross-sectional view of the non-aqueous battery according to the present invention.

FIG. 2 shows the SEM photograph of the positive active materials.

FIG. 3 shows the SEM photograph of the positive active materials with porous polymer electrolyte.

FIG. 4 shows the relation between the discharge capacity at 100th cycle and the amount of electrolyte according to example 1.

FIG. 5 shows the relation between the cell thickness at 100th cycle and the amount of electrolyte according to example 1.

FIG. 6 shows the relation between the discharge capacity at 100th cycle and the content of carbon dioxide according to example 2.

FIG. 7 shows the relation between the cell thickness at 100th cycle and the content of carbon dioxide according to example 2.

FIG. 8 shows the relation between the discharge capacity at 100th cycle and the amount of electrolyte according to the cells in example 3, example 4, example 5, comparative example 1 and comparative example 2.

### PREFERABLE EMBODIMENT OF THE INVENTION

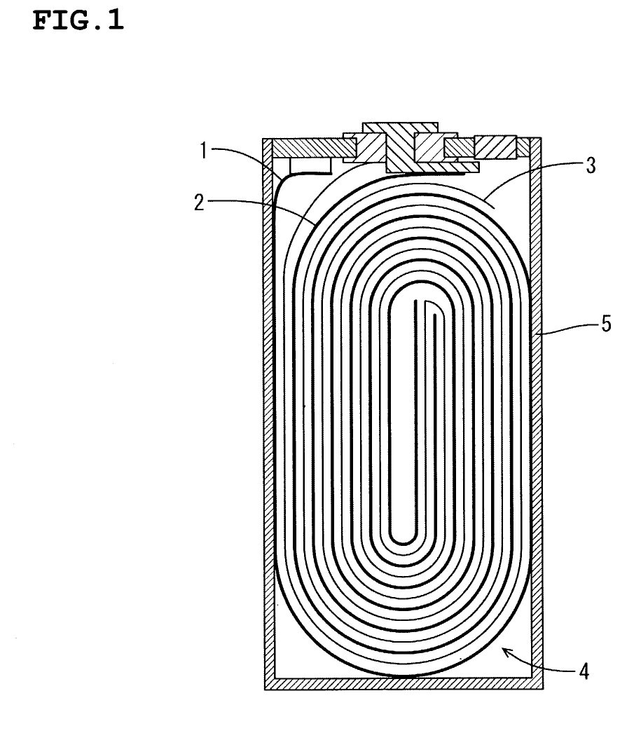

The non-aqueous battery according to the present invention is constructed by hosing the assembly elements 4 comprised of the positive electrode 1, negative electrode 2, and separators 3 put between electrodes into the sealed cell case 5 as shown in FIG. 1, wherein the amount of electrolyte is greater than or equal to 30% and less than or equal to 100% of the total pore volume of the assembly elements and the carbon dioxide content is greater than or equal to 1 volume % of the total gas contained in said cell case. The effect on the improvement of the cycle cell performance get appeared under the condition; the content of carbon dioxide is greater than or equal to 1 volume % of the total gas contained in said cell case. Especially in the greater than or equal to 10 vol. % of the total gas contained in the cell case, the cycle performance is remarkably improved by suppressing the electrolyte decomposition efficiently with enough of remaining carbon dioxide in the cell after the consumption of the gas for the formation of lithium carbonate. It is preferably to be the greater than or equal to 30 vol. % of the total gas contained in the cell case. The most preferable value is greater than or equal to 50 vol. % of the total gas contained in the cell case. Such an effect did not appear in the existing non-aqueous cells with the content of around 0.03 vol. % carbon dioxide of air. Where, the carbon dioxide content is defined by the formula: {the carbon dioxide volume/(carbon dioxide volume+the other contained gas)}×100/vol. %. These gas-volumes are measured by gas chromatograph. The other gas composition besides carbon dioxide gas in the cell case is not specially limited, but the air is preferable from the viewpoint of cost. The present invention produces the cells wherein the content of carbon dioxide is greater than or equal to 1 vol. % of the total gas contained in the cell case after injecting the carbon dioxide gas through the hole formed in the cell case followed by closing the hole with a same material ball by the welding process. This process is easily controlled to set up the appropriate value of carbon dioxide content for the superior cycle life performance. There is another method using the pre-mixing active materials with lithium carbonate for the positive electrode by which method the carbon dioxide gas is evolved in the sealed cell. This method is, however, difficult to control the amount of gas evolution in a cell. The turn of the process of injection of carbon dioxide into the cell is preferably to be conducted before or after the process of pouring the electrolyte into cell. The injections of carbon dioxide and the electrolyte are also to be conducted at the same time. The first charging process is to be conducted after or before the injection process of carbon dioxide into cells. The injection process of carbon dioxide is also conducted during the first charging process. The existing of carbon dioxide gas is preferable at the fist charging process since the distribution of electrolyte is uneven within cells before the repeating charge-discharge cycles resulting in the suppression of gas evolution by the even formation of coated film on the negative active materials. The sealing process is to be preferably conducted before or after the first charging process. The injection of carbon dioxide into cells is preferably conducted after the reduction in the pressure of cells. This process improves the efficiency of cell-production by increasing the injection speed of electrolyte into cells. The value of reduced pressure is preferably lower than or equal to 0.09 Mpa. More preferably, the value is lower than or equal to 0.05 Mpa. The most preferably value is lower than or equal to 0.01 Mpa. The value of internal pressure within cells after sealing process is preferably to be lower than or equal to the value of the outer pressure of the surrounding atmosphere.

The non-aqueous cells according the present invention has the small amount of electrolyte restricted to the value of greater than or equal to 30% and less than or equal to 100% of the total pore volume of the assembly elements resulting the enhancement in safety performance. The value of total pore volume of the assembly elements is determined as follows. First, the assembly elements are taken out of the case in the discharged state. The positive electrode, the negative electrode and the separator were then rinsed by a solvent such as dimethyl carbonate. Finally, these assembly elements were dried. The value is calculated from the analytical values of all materials composed of these elements, their outer volumes, and the values of density of each material composed of these elements. The value is also calculated from the results by the mercury penetration method with so called “mercury porosi-meter” in the case of electrodes comprising the materials not-amalgamated. Furthermore, the value is obtained using the measurement value of the impregnated volume of the solution such as an organic solvent as an alternative use of mercury of mercury-penetration method. Needles to say, the change in thickness of positive electrode, negative electrode, and separator was observed with cycling of charge-discharge.

The volume of electrolyte (ml) in cell is measured as follows. First, the mass C₁ (g) of cell is measured. The composition of electrolyte is then determined by the results of liquid chromatography after the extraction of its electrolyte from the cell components using the solvent such as DMC to obtain the density d (g/ml) of its electrolyte. Finally, the mass C₂ (g) of cell is measured after drying subsequent to rinsing their components with a solvent. The volume (ml) of electrolyte is calculated by the formula of (C₁−C₂)/d.

The positive active materials according to the present invention are the compounds capable of absorbing and desorbing lithium ion for example: composite oxide represented by the composition formula of LixMO₂ or LixM₂O₄ wherein M is transition metals, 0≦x≦1, 0≦y≦2; oxide with tunnel pore structure; and chalcogen compounds with the layered structure. For their concrete examples of the inorganic compounds, there are LiCoO₂, LiNiO₂, LiMn₂O₄, NiOOH, LiFeO₂, TiO₂, V₂O₅, and MnO₂ wherein the metal element is to be replaced by the other elements such as LiCo_{0.9}Al_{0.1}O₂, LiMn_{1.85}Al_{0.15}O₄, LiNl_{0.5}Mn_{1.5}O₄, and Ni_{0.80}Co_{0.2}OOOH. For their organic compounds, there are the electro-conductive polymers such as a polyaniline. In addition, the above-mentioned active materials are also to be mixed for the practical use. Especially the nickel containing materials in this invention are preferably used as a positive active material for the drastic improvement of cycle life performance at the higher temperature since the pre-formation of the protection film on its surface with the pre-injection of carbon dioxide is to be considered to suppress the gas evolution of carbon dioxide caused by the oxidation decomposition of electrolyte easily taken place on the surface of the nickel containing active materials at higher temperature.

The nickel-containing compounds of positive active materials according to the present invention are not limited by the representative examples of lithium nickelate, lithium nickel spinel oxide, and oxy-nickel hydroxide. As for lithium nickelate, there are LiNi_{0.8}Co_{0.2}O₂, LiNi_{0.80}Al_{0.20}O₂, and LiNi_{0.80}Co_{0.17}Al_{0.03}O₂ as the alternative compounds of the substitution of another element for the portion of nickel element.

As for lithium nickel spinel oxide, it is the Li-containing composite oxides represented by the general formula of LiₓNi_{y}Mn_{2-y}O₄ (0≦x≦1, 0.45≦y≦0.6), wherein the mol ratio of sum of nickel and manganese to oxygen is not strictly defined as 2:4, but its compound includes the oxygen deficit or oxygen surplus materials. In addition, the portion of nickel and manganese elements is to be replaced by other elements such as cobalt, iron, chromium, zinc, aluminum, and vanadium. As for the case of oxy-nickel hydroxide, the portion of nickel is to be replaced by another elements. Furthermore, the addition of another positive active materials to these nickel containing compounds materials is effective for the present invention; the additional materials are lithium cobaltate, lithium manganese composite oxide and the like. The additional additives of electro-conductive materials are to be mixed into the positive active materials; the effective materials are acetylene black, carbon black, electro-conductive polymer, and the like.

The negative active materials according to the present invention are to be the following materials: the carbon materials such as the graphitizable carbon such as coke, mesocarbon microbeads (MCMB), mesophase pitch-based carbon fiber, and pyrolytic vapor grown carbon fiber; non-graphitizable carbon such as sintered phenolic resin, polyacrylonitrile-based carbon fiber, pseudoisotropic carbon, sintered furfuryl alcohol resin; graphite-based material such as natural graphite, artificial graphite, graphitized MCMB, graphitized mesophase pitch-based carbon fiber, graphite whisker and their mixed materials; the alloy of metallic lithium with Al, Si, Pb, Sn, Zn, Cd and so on; the transition metal composite oxide of LiFe₂O₃, WO₂, MoO₂ and so on; Lithium nitride of Li₃₋ₓMₓN Li wherein M is the transition metal, 0≦x≦0.8; metallic lithium; and their mixed materials.

The materials of the current collector for positive electrode and negative electrodes are to be iron, cupper, aluminum, stainless steel, and nickel. Its embodiment is to be sheet, formed substrate, sintered substrate, expanded grid, and their perforated embodiment with a selected shape.

The same material made of porous polymer electrolyte is used for the binder bonding the active materials, electro-conductive additives, and current collector each other, since its material is suitable to be flexibility for the compensation of the volume change caused by the expansion-shrinkage of active materials during charge-discharge process. For example as a material for the positive's binder, the polymer containing fluorine is preferable from the view point of electrochemical stability such as PVdF, P(VdF/HFP), fluorine-based elastomer, and their derivatives of which materials are to be used solely or plurally. As for the case of negative's, the polymer containing fluorine such as PVdF, P(VdF/HFP), fluorine-based elastomer, and their derivatives is also to be used as well as the materials such as styrene-butadiene rubber, ethylene propylene rubber, carboxymethyl cellulose, methyl cellulose, and their derivatives. These materials are to be used solely or plurally.

The micro-porous film of polyethylene and polypropylene is used as a separator as well as the porous polymer electrolyte of PVdF, P(VdF/HFP) and the like. These films are also to be used as the combination separators. The cell case is made of materials: stainless, iron, and aluminum metals; polyethylene and polypropylene polymers; and the lamination layers of metal and polymer.

The aprotic solvent is preferably to be used as a solvent of the electrolyte. For examples as the concrete materials, there are EC, propylene carbonate, butylene carbonate, DMC, DEC, ethyl methyl carbonate, γ-butyrolactone, sulfolane, dimethyl sulfoxide, acetonitrile, dimethylformamide, dimethyl acetamide, 1,2-dimethoxyethane, 1,2-diethoxyethane, tetrahydrofura, 2-methyltetrahydrofuran, 1,3-dioxolane, methyl acetate, NMP, 4-methyl-1, 3-dioxolane, N-methyl pyrrolidine, ethyl methyl ketone, methyl propionate, acetone, diethyl ether, ethyl methyl ether, dimethyl ether and so on. These solvents are also to be used as their mixture.

The suitable lithium salts of electrolyte are LiPF₆, LiBF₄, LiAsF₆, LiClO₄, LiSCN, Lil, LiCF₃SO₃, LiC₄F₉SO₃, Li(CF₃SO₂)₂N, LICl, LiBr, LiCF₃CO₂ and their mixtures.

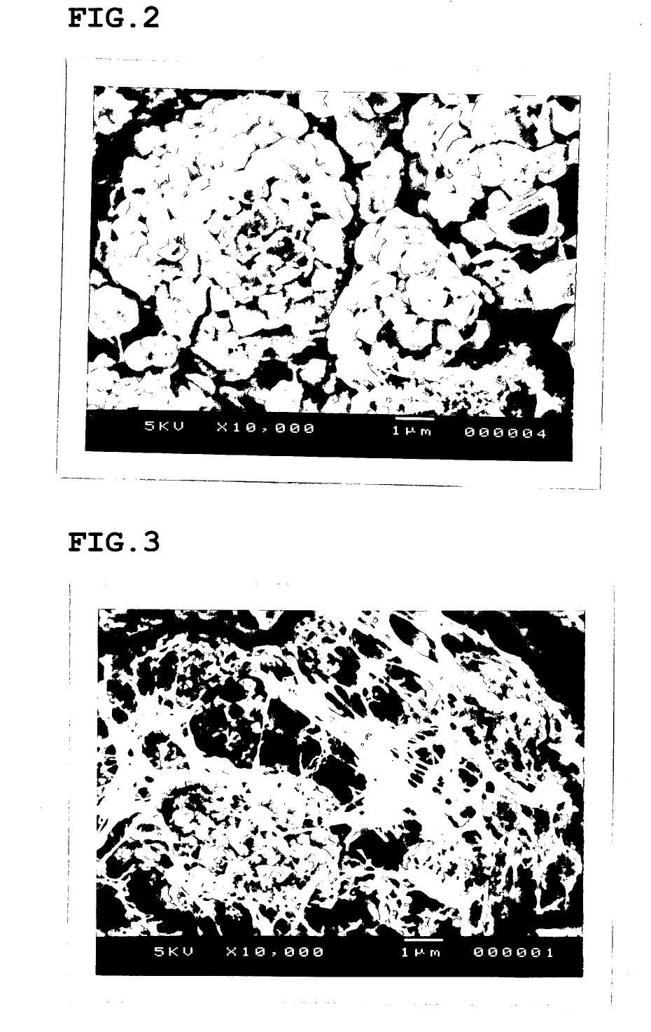

As the preferable embodiments according to the present invention, the porous polymer electrolyte is held at least partly or fully in the pore and surface of assembly elements of the positive, the negative and separator. The porous polymer electrolyte is defined as the combination of the porous polymer and electrolyte, wherein the lithium ions is to be moved through both the electrolyte in the pores and the polymer material itself swollen or wetted with the used electrolyte. The preferable configuration for polymer electrolyte is mesh-like, more preferably three-dimensional net structure. For reference, FIG. 2 and FIG. 3 show the electron microscopic photographs on the surface of active materials and the formation of porous polymer thereon respectively. The porosity of porous polymer electrolyte is preferably greater than or equal to 10% and less than or equal to 90%, more preferably greater than or equal to 30% and less than or equal to 90%. The most preferable value is greater than or equal to 40% and less than or equal to 80%. The material is suitable to be flexibility for the compensation of the volume change caused by the expansion-shrinkage of active materials during charge-discharge process. In addition, the polymer is preferable to show the wet-ability or the swollen property with the electrolyte. For example as a material for this polymer, there are polyvinylidene fluoride(PVdF), polyacrylonitrile(PAN), polyethylene oxide(PEO), polypropylene oxide(PPO), polymethyl methacrylate(PMMA), polyvinyl fluoride, polyvinyl chloride, polyvinylidene chloride, polymethyl acrylat, polymethacrylonitrile, polyvinyl acetate, polyvinyl pyrrolidone, polyethylene terephthalate, polyhexamethylene adipamide, polycaprolactam, polyvinyl alcohol, polyurethane, polyethyleneimine, polycarbonate, polytetrafluoroethylene, polyethylene, polypropylenepolybutadiene, polystyrene, polyisoprene, carboxymethyl cellulose, methyl cellulose, and their derivatives. These materials are also to be used solely or plurally. Furthermore,

the monomer composed of their polymer is to be used in the combination with their monomer; for example, the vinylidene fluoride-hexafluoropropylene copolymer (P(VdF/HFP), styrene-butadiene rubber, ethylene propylene rubber, styrene-based elastomer, fluorine-based elastomer, olefin-based elastomer, and so on, wherein the PVdF, P(VdF/HFP), PAN, PEO, PPO, PMMA and their derivatives are preferably to be used solely or plurally. The polymer containing fluorine such as PVdF and P(VdF/HFP) are most preferable to be used in the all parts of elements of positive electrode, negative electrode, and separator, since these materials are electrochemically stable compared with the other polymer materials resulting in the better cycle performance through the even distribution of electrolyte among these elements.

The preferable method to manufacture the porous polymer electrolyte process is the phase separation of the polymer from its dissolved solution. The method is to use the temperature change of heating or cooling the solution, the concentration change of evaporating the solvent, and the extraction of solvent from the solution as the most preferable one. The concrete process of the solvent-extraction method comprises the following procedure: the polymer solution dissolved said polymer material by the first solvent is immersed in the second solvent with the feature of both in-dissolution of said polymer and mutual solution of the first solvent resulting in the pore formation of the portion of the first solvent by displacement of the second solvent. The pore configuration is generally circular by this process. The another process using the solubility change by temperature is also preferably adopted to produce the porous polymer electrolyte in which the polymer material is solved in the third solvent followed by cooling the solvent to be the super-saturation of this polymer in the third solvent resulting in the phase separation of the polymer and the third solvent followed by excluding said third solvent. The first solvent is to dissolve the polymer for example, carboxylic acid ester such as propylene carbonate, EC, DMC, diethyl carbonate(DEC), ethyl methyl carbonate, and so on, ether such as dimethyl ether, diethyl ether, ethyl methyl ether, tetrahydrofuran and so on, ketone such as ethyl methyl ketone and acetone and so on, dimethyl formamide, dimethyl acetamide, 1-methyl-pyrrolidinone, N-methyl-2-pyrrolidone(NMP) and so on. The second solvent is to be insoluble to the polymer and soluble to the first solvent, for example, water, alcohol, acetone, and so on. Their mixture solvents are also used. The third solvent is preferable to have a low solubility at a temperature and a higher solubility beyond that temperature, for example, ketone such as ethyl methyl ketone and acetone, carboxylic acid ester such as propylene carbonate, EC, DMC, DEC and ethyl methyl carbonate, ether such as dimethyl ether, diethyl ether, ethyl methyl ether, and tetrahydrofuran, dimethyl formamide and so on. The ketone among them is preferable, and ethyl methyl ketone is more preferable.

The formation of porous polymer electrolyte in the electrodes is preferably to take the first process of holding the polymer solution in the pore of the positive and negative electrodes followed by the second process of separation of polymer material from the polymer solution. The first process may remove the excess the polymer solution on the electrodes, for the concrete instance, removing the excess solution on the electrodes by roller and blade machines after immersing the electrodes into the polymer solution. The first process is preferable conducted before pressing the electrodes.

The formation of porous polymer electrolyte on the electrodes is preferably to take the first process of applying the polymer solution on the surface of the positive and negative electrodes followed by the second process of separation of polymer material from the polymer solution wherein the second process is to be conducted by the same manufacturing process of the porous polymer electrolyte already described before. The first process may remove the excess the polymer solution on the electrodes after applying the polymer solution on them or transfer the polymer solution itself, for the concrete instances; removing the excess solution on the electrodes by roller and blade machines after immersing the electrodes into the polymer solution; and transferring the polymer solution produced once on the roller or the board to the surface of electrodes. The first process is preferable conducted before pressing the electrodes. The second process is to be also conducted by the same manufacturing process of the porous polymer electrolyte already described before. The proper thickness of the porous polymer electrolyte formed on the positive and negative electrodes is expressed by the following formula: 5 μm<(Tp+Tn+Ts)<50 μm, where Tp, Tn, Ts is the thickness value of the positive, the negative, and the separator respectively. More preferably, (Tp+Tn+Ts)<25 μm is recommended.

The formation of porous polymer electrolyte on the separator is preferably to take the first process of applying the polymer solution in the separator followed by the second process of separation of polymer material from the polymer solution wherein the first process is to be conducted by the same manufacturing process of the porous polymer electrolyte on the surface of electrodes already described before. The second process is also to be conducted by the same manufacturing process of the porous polymer electrolyte already described before. The proper thickness of the porous polymer electrolyte formed on the separator is expressed by the following formula: 5 μm<(Tsp+Ts)<50 μm, where Tsp, Ts is the thickness value of the porous polymer electrolyte on the separator and its separator respectively. More preferably, (Tsp+Ts)<25 μm is recommended. Furthermore, the porous polymer electrolyte is to be held in the pore of separator.

The adhesion of separator at least to one of the positive and negative electrodes with the porous polymer electrolyte is conducted by the heating process of the cells at around the melting point temperature of porous polymer electrolyte. The small portion of the porous polymer electrolyte in the heating process is melted and then solidified after cooling resulting in the adhesion of the separator to at least one of the positive and negative electrodes with its polymer electrolyte. This heating process may be conducted before holding the electrolyte in the porous polymer. The porous polymer electrolyte is preferable to be applied at least to one of the positive and negative electrodes when the cells with electrolyte are heated for the conjunction of separator and electrodes wherein the porous polymer electrolyte is drastically absorbed with electrolyte by the heating process. The unevenness of porous polymer electrolyte within a cell is to be the uneven distribution of electrolyte resulting in the decrease of cell performance. Especially, the very small amount of electrolyte in the separator is moved to the electrodes when the porous polymer electrolyte is not contained in the separator resulting in the drastic decrease of cell performance. The some examples according to the present are concretely described below.

### EXAMPLE 1

The positive electrode was produced as follows. First, lithium nickelate(LiNi_{0.85}Co_{0.15}O₂) 55 wt %, acetylene black 2 wt %, PVdF 4 wt %, and NMP 39 wt % were mixed and the mixture was applied to the both sides of aluminum foil with 100 mm width, 600 mm length, 20 μm thickness, followed by drying at 100° C. The coated foil was cut to be the thin electrode with size of 26 mm width and 495 mm length, after pressing it from 270 μm to 165 μm in thickness.

The negative electrode was produced as follows. First, graphite 50 wt %, PVdF 5 wt %, and NMP 45 wt % were mixed and the mixture was applied to the both sides of cupper foil with 100 mm width, 600 mm length, 10 μm thickness, followed by drying at 100° C. The coated foil was cut to be the thin electrode with size of 27 mm width and 450 mm length, after pressing it from 250 μm to 195 μm in thickness.

The assembly element wounded the positive electrode and negative electrodes with the polyethylene separator of 25 μm thickness, 29.5 μm width was inserted in the aluminum cell case with a dimension of 48.0 mm height, 29.2 mm width, and 5.0 mm thickness followed by pouring the electrolyte of 0.4 g-2.6 g with the concentration of 1 mol/l LiPF₆ in the mixed solution of EC and DEC; volume ratio of 1:1. The amount of electrolyte was 20, 30, 40, 50, 60, 70, 80, 90, 100, 110, 120, and 130% of the total volume of the pore of the assembly elements of electrodes and separator. The value of 100% corresponded to 2.00 g of the electrolyte. The cells were vacuumed to the reduced pressure of 0.06 MPa followed by the injection of carbon dioxide gas to the normal atmosphere pressure. The content of carbon dioxide gas in the cells was 80 vol. % after the several times of this procedure. The cells with a nominal capacity of 740 mAh were produced by closing the hole of the case after charging at 148 mA for 1 hour. The cells had the non-regulated safety valve. The 12 types of cells with different amount of electrolyte were named group(A). The 12 types of cells group(B) of the same as group(A) except of the injection of air instead of carbon dioxide gas were also produced for references. Furthermore, the 12 types of cells group(C) by the same way as group(A) were produced using the porous polymer electrolyte on the positive and negative active materials, in the pore of the positive and negative electrodes, and on the surface of the separator described by the following procedures.

As for the preparation of lithium nickelate with porous polymer electrolyte, the P(VdF/HFP) solution was at first prepared by dissolving 10 g P(VdF/HFP) into 990 g NMP wherein the molar ratio of VdF to HFP was 95:5. This polymer was used in the examples in the present invention without the extra mention on it from now on. The lithium nickelate of 800 g was mixed with 400 g of P(VdF/HFP) solution and the polymer solution was then held among the active materials particles by mixing it under 0.0001 MPa reduced pressure. The excess polymer solution on the positive active materials was eliminated by absorbing filter followed by the immersion in the ethylalcohol. The lithium nickelate with P(VdF/HFP) was finally dried at 100° C.

As for the preparation of graphite with porous polymer electrolyte, The graphiteof 800 g was first mixed with 740 g of P(VdF/HFP) solution and the polymer solution was then held among the active materials particles by mixing it under 0.0001 MPa reduced pressure. The excess polymer solution on the mixed materials was eliminated by absorbing filter followed by the immersion in the de-ionized water. The graphite with P(VdF/HFP) was finally dried at 100° C.

The positive and negative electrodes were produced using the above-mentioned active materials as follows. As for the positive electrodes, lithium nickelate (LiNi_{0.85}Co_{0.15}O₂) 55 wt %, acetylene black 2 wt %, PVdF 4 wt %, and NMP39 wt % were mixed and the mixture was applied to the both sides of aluminum foil with 100 mm width, 600 mm length, 20 μm thickness, followed by drying at 100° C. As for the negative electrode, graphite 50 wt %, PVdF 5 wt %, and NMP 45 wt % were mixed and the mixture was applied to the both sides of cupper foil with 100 mm width, 600 mm length, 10 μm thickness, followed by drying at 100° C. The positive and negative electrodes were immersed in 6 w % and 4 wt % P(VdF/HFP) respectively to impregnate these solutions into the pores of electrodes followed by removing the excess solution on the electrodes by roller machine. The positive and negative electrodes were then immersed into the de-ionized water with a concentration of 0.0001 mol/l phosphate and de-ionized water respectively to extract NMP resulting in the formation of porous polymer electrolyte within the pores of electrodes. The positive electrode was cut to be the thin electrode with size of 26 mm width and 495 mm length, after pressing it from 270 μm to 165 μm in thickness. The negative electrode was cut to be the thin electrode with size of 27 mm width and 450 mm length, after pressing it from 250 μm to 195 μm in thickness. The assembly element wounded the positive electrode and negative electrodes with the PVdF separator of 25 μm thickness, 29.5 mm width was inserted in the aluminum cell case with a dimension of 48.0 mm height, 29.2 mm width, and 5.0 mm thickness followed by pouring the electrolyte with the concentration of 1 mol/l LiPF₆ in the mixed solution of EC and DEC; volume ratio of 1:1. The amount of electrolyte was changed to be 12 types described before. The carbon dioxide gas was then injected to be the content of carbon dioxide gas of 80 vol. %. The cells with a nominal capacity of 740 mAh were produced by closing the hole of the case after charging at 148 mA for 1 hour. The cells had the non-regulated safety valve.

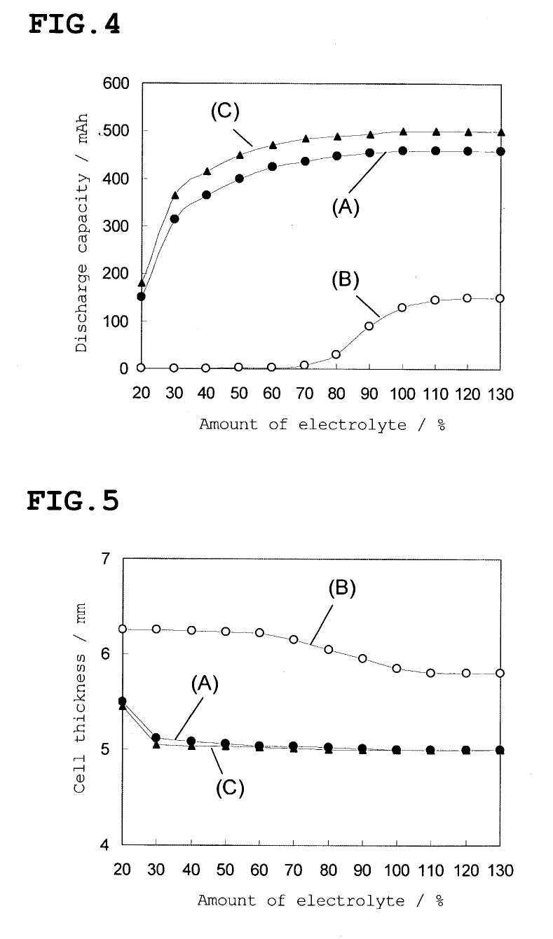

The high temperature cycle test was conducted by 100 repeated cycles for the cells of group(A), group(B), and group(C) under the following condition; the discharge was at 740 mA to 2.75 V after charging of 740 mA to 4.2V at the temperature of 45° C. FIG. 4 shows the relation between the discharge capacity at the 100th cycle and the amount of electrolyte. FIG. 5 shows the relation between the cell thickness at the 100th cycle and the amount of electrolyte. The symbols ●, ◯, ▴ stand for group(A), group(B), and group(C) respectively in FIG. 4 and FIG. 5. These figures showed the drastic improvement in the cycle performance of the cells injected carbon dioxide gas, especially for the cells with the amount of electrolyte of the value of greater than or equal to 30% and less than or equal to 100% of the total pore volume of the assembly elements resulting the enhancement of cell performance. Furthermore, the increment in thickness of cells injected carbon dioxide gas was hardly observed. This effect is derived from the even formation of film covered on the graphite by the even distribution of carbon dioxide gas within cells wherein the further formation of film by the change of the re-distribution of electrolyte during cycles is suppressed resulting in the drastic reduction of gas evolution within cells.

In addition, the cycle performance of cells with porous polymer electrolyte was found out to be drastically improved wherein the carbon dioxide gas diffused through the pores of the porous polymer to reach easily to the surface of active materials. The formation of the coated film of lithium carbonate evenly is considered to be formed on that surface of their active materials at the site of the pore of the polymer electrolyte wherein the coated film suppresses the gas evolution of carbon dioxide by the oxidation-reduction decomposition of electrolyte. The lithium ion is more easily transferred in the part of the site of the polymer electrolyte materials not covered by lithium carbonate film result in the even current-distribution and a longer life cycle performance compared with the performance of the cells with no porous polymer electrolyte. As the further effect, the porous polymer electrolyte showed the wet-ability or the swollen property with the electrolyte resulting in holding the electrolyte tightly in its porous polymer electrolyte. Therefore, the shortage of electrolyte during cycles was hard to be observed for the cells with the porous polymer electrolyte resulting in the longer cycle life compared with the case of the cells with no porous polymer. Even in the case of the application of the porous polymer electrolyte only on the surface of the positive and negative active materials or only in the pore of the positive and negative electrodes, the cycle performance of cells was improved compared with that of cells with no application of porous polymer electrolyte. This effect is considered to be the similar effect observed in the case of the application of the porous polymer electrolyte to both on the surface of active materials and in the pores of electrodes as described before.

### EXAMPLE 2

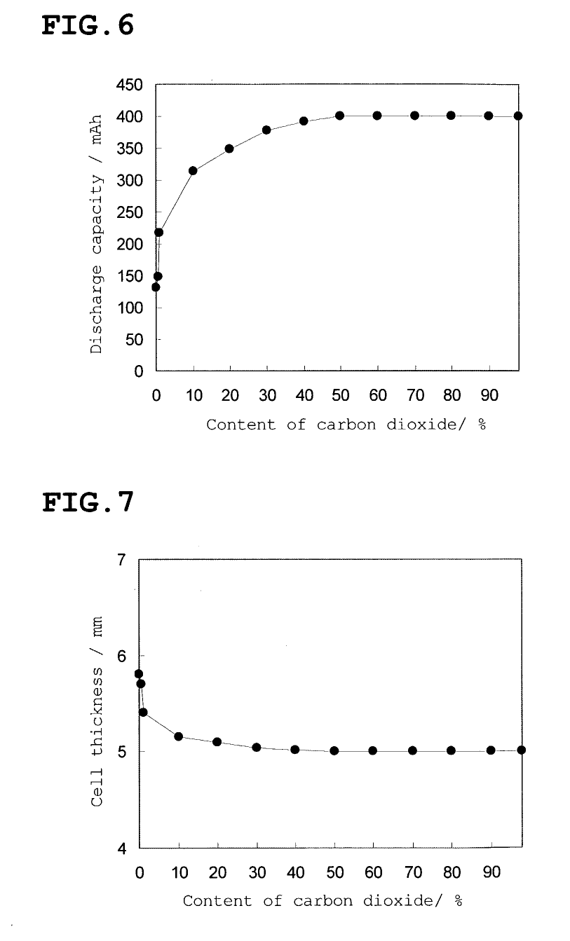

The effect of concentration of carbon dioxide gas within the cells on the cycle performance was investigated at the higher temperature. The manufacture process of assembly elements comprising positive electrode, negative electrodes and separators was the same as the case of group(A) in example 1. The value of concentration for carbon dioxide gas was 0.5%, 1%, 10%, 20%, 30%, 40%, 50%, 60%, 70%, 80%, 90%, and 98 vol. %. The cell injected only with air was prepared for reference in comparison; the concentration of carbon dioxide gas was 0.03 vol. %. The amount of electrolyte was 50% of the total pores of the assembly elements comprising electrodes and separators. The cycle performance tests of these 13 types of cells in total were conducted at higher temperature under the similar condition of example 1. FIG. 6 shows the relation between the discharge capacity at the 100th cycle and the concentration of carbon dioxide gas. FIG. 7 shows the relation between the cell thickness at the 100th cycle and the concentration of carbon dioxide gas. These figures showed the improvement in the cycle performance of the cells with the concentration value of greater than or equal to 1% of carbon dioxide gas. In the value of greater than or equal to 1% of carbon dioxide gas, the cycle performance was found to be drastically improved. The best cycle performance was observed in the concentration of greater than or equal to 50% of carbon dioxide gas. Furthermore, the increment in thickness of cells injected carbon dioxide gas was found to be suppressed.

### EXAMPLE 3

The non-aqueous electrolyte cells with the positive electrode, the negative electrodes, and the separator applied the porous polymer electrolyte in the pores of their assembly elements were produced and the 12 types of cells with different amounts of electrolyte were prepared according the following procedure. These cells were named group(D). As for the positive electrodes, lithium nickelate (LiNi_{0.85}Co_{0.15}O₂) 55 wt %, acetylene black 2 wt %, PVdF 4 wt %, and NMP39 wt % were mixed and the mixture was applied to the both sides of aluminum foil with 100 mm width, 600 mm length, 20 μm thickness, followed by drying at 100° C. As for the negative electrode, graphite 50 wt %, PVdF 5 wt %, and NMP 45 wt % were mixed and the mixture was applied to the both sides of cupper foil with 100 mm width, 600 mm length, 10 μm thickness, followed by drying at 100° C. The positive and negative electrodes were immersed in 6 w % and 4 wt % P(VdF/HFP) respectively to impregnate these solutions into the pores of electrodes followed by removing the excess solution on the electrodes by roller machine. The positive and negative electrodes were then immersed into the de-ionized water with a concentration of 0.0001 mol/l phosphate and de-ionized water respectively to extract NMP resulting in the formation of porous polymer electrolyte within the pores of electrodes. The positive electrode was cut to be the thin electrode with size of 26 mm width and 495 mm length, after pressing it from 270 μm to 165 μm in thickness. The negative electrode was cut to be the thin electrode with size of 27 mm width and 450 mm length, after pressing it from 250 μm to 195 μm in thickness.

The polyethylene separator with porous polymer electrolyte was produced by the following process. The polyethylene separator with porosity of 40%, thickness 15 μm, and width 29.5 mm was prepared and immersed in the 20 wt % of P(VdF/HFP). The separator after the treatment of immersion was passed through two rollers followed by immersing the separator in the de-ionized water and then dried. The thickness of separator with the porous polymer electrolyte was 25 μm and the value of the porosity of the porous polymer electrolyte was 65%. The assembly element wounded the positive-electrode and the negative electrode with the separator was inserted in the aluminum cell case with a dimension of 48.0 mm height, 29.2 mm width, and 5.0 mm thickness followed by pouring the electrolyte with the concentration of 1 mol/l LiPF₆ in the mixed solution of EC and DEC; volume ratio of 1:1. The amount of electrolyte was from 0.40 g to 2.60 g; its amount was 20, 30, 40, 50, 60, 70, 80, 90, 100, 110, 120, and 130% of the total volume of the pore of the assembly elements of electrodes and separator. The value of 100% corresponded to 2.00 g of the electrolyte. The cells were vacuumed to the reduced pressure of 0.008 MPa followed by the injection of carbon dioxide gas to reach the value of 90 vol. %. The cells with a nominal capacity of 740 mAh were produced by closing the hole of the case after charging at 148 mA for 1 hour. The cells had the non-regulated safety valve.

### EXAMPLE 4

The non-aqueous electrolyte cells with the positive electrode and the negative electrodes applied the porous polymer electrolyte on the surface of these electrode were produced and the 12 types of cells with different amounts of electrolyte were prepared according the following procedure described below. These cells were named group (E). Namely, the pressed positive and negative electrodes were produced by the similar method in the case of example 3. The positive and negative electrode with the porous polymer electrolyte thereon their surfaces were then immersed in the 20 wt % of P(VdF/HFP). The electrodes after the treatment of immersion were passed through two rollers followed by immersing the positive electrodes and the negative electrode into the de-ionized water with a concentration of 0.01 mol/l phosphate and de-ionized water respectively and then dried. The thickness of the porous polymer electrolyte formed on the surface of electrodes was 5 μm and the value of the porosity of the porous polymer electrolyte was 65%. The group(E) cells were produced by the similar method of group(D) cells in example 3, except of the use of said positive and negative electrodes and the polyethylene separator without porous polymer electrolyte.

### EXAMPLE 5

The non-aqueous electrolyte cells with the conjunction of positive electrode, the negative electrode and separator by the adhesion of porous polymer electrolyte were produced and the 12 types of cells with different amounts of electrolyte were prepared according the following procedure; the group (D) cells were immersed in the water bath at the temperature of 95° C. for 5 min. The small part of porous polymer electrolyte was melted at that temperature and then solidified after cooling resulting in the adhesion of the separator to the positive and negative electrodes with its porous polymer electrolyte. These cells were named group (F).

### EXAMPLE 6

The non-aqueous electrolyte cells were produced by the similar method of group(D) cells in example 3, except of the use of polyethylene separator without porous polymer electrolyte. The 12 types of cells with different amounts of electrolyte were prepared and named group (F).

### COMPARATIVE EXAMPLE 1

The non-aqueous electrolyte cells were produced by the similar method of group (D) cells in example 3, except of the air injection within cells. The 12 types of cells with different amounts of electrolyte were prepared and named group (H).

### COMPARATIVE EXAMPLE 2

The non-aqueous electrolyte cells were produced by the similar method of group (G) cells in example 6, except of the air injection within cells. The 12 types of cells with different amounts of electrolyte were prepared and named group (I).

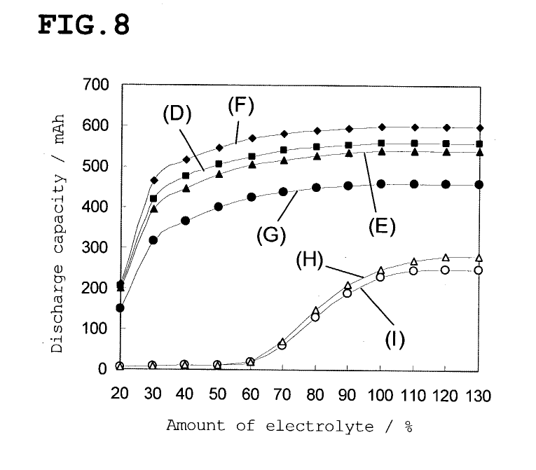

The experimental test of cells in example 3 to example 5 and comparative example 1 and comparative example 2, were conducted under the same condition described in example 1. FIG. 8 shows the relation between the discharge capacity at the 100th cycle and the amount of electrolyte to the total pore volume of the assembly elements of electrodes and separators. The symbols ▪, ▴, ♦, ●, Δ, ◯ stand for group(D), group(E), group(F), group(G), group(H), group(I) respectively in FIG. 8. The test results show that the cycle performance of group (D) cell, group (E) cell, group (F) cell, and group (G) cell are improved compared with the comparative example(H) cell and the comparative example(I). This is because the film formation of lithium carbonate caused by the reduction of carbon dioxide gas on the surface of graphite suppresses the reduction of electrolyte result in the reduction of the amount of gas evolution. In addition, the pre-injection of carbon dioxide is to be considered to suppress the evolution of carbon dioxide on the positive electrode. Especially, the cycle performance of cell(D), cell(E), and cell(F) was found to be drastically improved since the swollen porous polymer electrolyte decreased the gap between the separator and the positive and negative electrodes resulting in suppressing the occurrence of the shortage electrolyte in the gap. Therefore, the dendritic growth of metallic lithium is considered to be also suppressed.

### INDUSTRIAL APPLICABILITY

The safety performance of the non-aqueous cells according to the present invention is drastically improved by the tremendous reduction of flammable electrolyte. The cycle life performance is also drastically improved even in the small amount of electrolyte, because the carbon dioxide gas is injected in the cell case greater than or equal to the concentration of 1 vol. % wherein the carbon dioxide gas is reduced to form the film on the surface of the negative active materials of which surface is exposed to the carbon dioxide gas and dose not contact the electrolyte. Therefore, the cycle performance is improved by the suppression of the film formation progress with the gas evolution.

1. A non-aqueous cell having an assembly element comprising a positive electrode, a negative electrode, and a separator in a sealed case with the features: an amount of electrolyte is greater than or equal to 30% and less than or equal to 100% of the total pore volume of said assembly element; and a carbon dioxide content is greater than or equal to 1 volume % of the total gas contained in said sealed case.

2. The non-aqueous cell according to claim 1, wherein said carbon dioxide content is greater than or equal to 10 volume % of the total gas contained in said sealed case.

3. The non-aqueous cell according to claim 1 and claim 2, wherein a porous polymer electrolyte is formed on the surface of a positive active material or/and a negative active material.

4. The non-aqueous cell according to claim 1, claim 2, and claim 3, wherein a porous polymer electrolyte is formed on the pore of said positive electrode or/and said negative electrode.

5. The non-aqueous cell according to claim 1, claim 2, claim 3, and claim 4, wherein a porous polymer electrolyte is formed on the surface of said positive electrode or/and said negative electrode.

6. The non-aqueous cell according to claim 1, claim 2, claim 3, claim 4, and claim 5, wherein a porous polymer electrolyte is formed on said separator.

7. The non-aqueous cell according to claim 1, claim 2, claim 3, claim 4, claim 5, and claim 6, wherein said separator is the conjunction with at least one of said positive electrode and said negative electrode by the adhesion of a porous polymer electrolyte.

8. The non-aqueous cells according to claim 1, claim 2, claim 3, claim 4, claim 5, claim 6, and claim 7, wherein a positive active material is Lithium nickelate, lithium nickel spinel oxide, and oxy-nickel hydroxide.

9. A method for producing a non-aqueous cell comprising the processes: a process manufacturing an assembly element of a positive electrode, a negative electrode, and a separator; a process inserting said assembly element into a cell case; a process pouring an amount of electrolyte of greater than or equal to 30% and less than or equal to 100% of the total pore volume of said assembly element into said cell case; and a process injecting a carbon dioxide content of greater than or equal to 1 volume % of the total gas contained in said cell case followed by sealing said cell case.

10. A method for producing a non-aqueous cell comprising the processes: a process coating a polymer solution on the surface of a positive active material or/and a negative active material; a process producing a porous polymer on the surface of said positive active material or/and said negative active material by extracting a solvent from said polymer solution; a process manufacturing a positive electrode with said active material or/and a negative electrode with said active material; a process manufacturing an assembly element of the said positive electrode, said negative electrode, and separator; a process inserting said assembly element into a cell case; a process pouring an amount of electrolyte of greater than or equal to 30% and less than or equal to 100% of the total pore volume of said assembly element into said cell case; and a process injecting a carbon dioxide content of greater than or equal to 1 volume % of the total gas contained in said cell case followed by sealing said cell case.

11. A method for producing a non-aqueous cell comprising the processes: a process holding a polymer solution in the pores of a positive electrode or/and a negative electrode; a process producing a porous polymer in the pores of said positive electrode or/and said negative electrode by extracting a solvent from said polymer solution; a process manufacturing an assembly element of the said positive electrode, said negative electrode, and separator; a process inserting said assembly element into a cell case; a process pouring an amount of electrolyte of greater than or equal to 30% and less than or equal to 100% of the total pore volume of said assembly element into said cell case; and a process injecting a carbon dioxide content of greater than or equal to 1 volume % of the total gas contained in said cell case followed by sealing said cell case.

12. A method for producing a non-aqueous cell comprising the processes: a process applying a polymer solution to the surface of a positive electrode or/and a negative electrode; a process producing a porous polymer on the surface of said positive electrode or/and said negative electrode by extracting a solvent from said polymer solution; a process manufacturing an assembly element of said positive electrode, said negative electrode, and said separator; a process inserting said assembly element into a cell case; a process pouring an amount of electrolyte of greater than or equal to 30% and less than or equal to 100% of the total pore volume of said assembly element into said cell case; and a process injecting a carbon dioxide content of greater than or equal to 1 volume % of the total gas contained in said cell case followed by sealing said cell case.

13. A method for producing a non-aqueous cell comprising the processes: a process applying a polymer solution to a separator; a process producing a porous polymer on said separator by extracting a solvent from said polymer solution; a process manufacturing an assembly element of a positive electrode, a negative electrode, and said separator; a process inserting said assembly element into a cell case; a process pouring an amount of electrolyte of greater than or equal to 30% and less than or equal to 100% of the total pore volume of said assembly element into said cell case; and a process injecting a carbon dioxide content of greater than or equal to 1 volume % of the total gas contained in said cell case followed by sealing said cell case.
